(19) United States
(12) Patent Application Publication
(10) Pub. No.: US 2014/0358992 A1
(43) Pub. Date: Dec. 4, 2014

(54) IMAGES MONITORING AND BROADCASTING SYSTEM AND METHOD

(71) Applicant: HON HAI PRECISION INDUSTRY CO., LTD., New Taipei (TW)

(72) Inventors: JEN-HUNG LO, New Taipei (TW); EN-SHIH LIN, New Taipei (TW); PANG-HAO LIU, New Taipei (TW); CHIH-CHIEN CHENG, New Taipei (TW); LI-KANG HUNG, New Taipei (TW); KIA-MING PHUA, New Taipei (TW)

(73) Assignee: HON HAI PRECISION INDUSTRY CO., LTD., New Taipei (TW)

(21) Appl. No.: 14/133,721

(22) Filed: Dec. 19, 2013

(30) Foreign Application Priority Data
May 30, 2013 (TW) 102119055

(51) Int. Cl. H04L 29/08

(52) U.S. Cl. CPC H04L 67/10
USPC 709/203

(57) ABSTRACT

An image monitoring and broadcasting method is executed by a first electronic device. A user interface of the first electronic device is displayed. When a monitoring or a broadcasting command is received from the user interface, the method acquires connection information of the second electronic devices which have been connected to the server. If the monitoring command is received, the method transmits connection information of the first electronic device and a preset monitoring notice to the second electronic devices, receives images transmitted from the second electronic devices to be displayed on the user interface. If the broadcasting command is received, the method transmits a preset broadcasting notice images displayed on the first display screen to the second electronic devices.

### BACKGROUND

1. Technical Field

Embodiments of the present disclosure relate to monitoring technology, and more particularly to an image monitoring and broadcasting system and a method.

2. Description of Related Art

When a teacher uses a personal computer to teach and communicate with students in a class, the teacher often needs to show images displayed on the personal computer to the students. Sometimes, the teacher also needs to monitor or check images displayed on computers of the students. The teacher may use desktop sharing technology to share the images on the personal computer with the students. However, it is inefficient for the teacher to connect to the computers of the students one by one. Furthermore, it is also inconvenient and inefficient for the teacher to monitor the images on the computers of the students.

### BRIEF DESCRIPTION OF THE DRAWINGS

FIG. 1 is a block diagram of one embodiment of an application environment of a first electronic device including an image monitoring and broadcasting system.

FIG. 2 is a block diagram of one embodiment of function modules of the image monitoring and broadcasting system in FIG. 1.

FIG. 3 is a flowchart of one embodiment of an image monitoring and monitoring method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

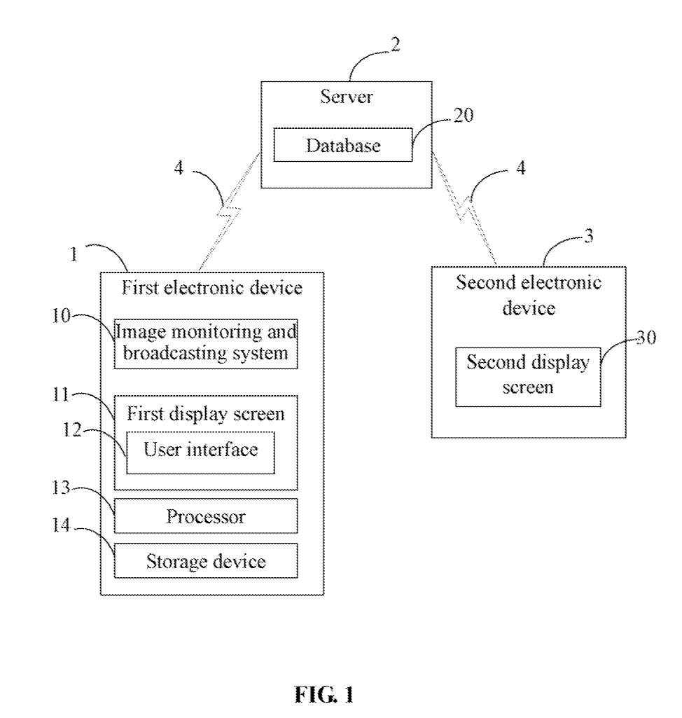

FIG. 1 is a block diagram of one embodiment of a first electronic device 1 including an image monitoring and broadcasting system 10. The first electronic device 1 is connected to a server 2 and one or more second electronic devices 3 via a wireless network 4. The wireless network 4 can use short distance wireless communication technology, such as IEEE802.11b (Wi-Fi) technology, for example.

In one embodiment, the first electronic device 1 is considered as a device for monitoring the second electronic devices 3, and each second electronic device 3 is considered as a device for being monitored by the first electronic device 1. For example, the first electronic device 1 is carried by a teacher, and the second electronic devices 3 are carried by students. The first electronic device 1 includes a first display screen 11 for displaying a user interface 12. Each of the second electronic devices 3 includes a second display screen 30 for displaying data of the second electronic device 3.

The user interface 12 includes an initial interface. The initial interface displays an monitoring button and a broadcasting button. The user of the first electronic device 1 can use a finger, a stylus, or a mouse (not shown in FIG. 1) to press (or click) the buttons on the initial interface to execute a monitoring command or a broadcasting command for the first electronic device 1. The monitoring command is a command of monitoring images of the second electronic devices 3, and the broadcasting command is a command of broadcasting images of first electronic device 1.

The user interface 12 further includes a monitoring interface. The monitoring interface displays a plurality of identifier (e.g. name or ID) fields and image fields corresponding to the identifier fields. The image fields may display images transmitted from the second electronic devices 3 that are required to be monitored by the first electronic device 1. The identifier fields are established corresponding to account names of the second electronic devices 3.

The server 2 includes a database 20 for storing registration information of each of the first electronic device 1 and the second electronic devices 3. The registration information includes an account name, a password, and other personal information. In one embodiment, the first electronic device 1 or the second electronic device 3 is connected to the server 2 by inputting an account name and a password via the wireless network 4. The server 2 compares the input account name and the input password with the registration information to determine whether the first electronic device 1 or the second electronic device 3 is connected to the server 2 successfully.

In one embodiment, after the first electronic device 1 or the second electronic device 3 is connected to the server 2, the server 2 records connection information of the first electronic device 1 or the second electronic device 3. The connection information includes, but is not limited to, the account name and an identification code representing an identifier, such as an Internet Protocol (IP) address.

The first electronic device 1 further includes at least one processor 13 and a non-transitory storage device 14. The storage device 14 is a dedicated memory, such as an EPROM, a hard disk driver (HDD), or flash memory. The storage device 14 stores data of the first electronic device 1. The processor 13 executes one or more computerized codes and other applications for the first electronic device 1, to provide the functions of the image monitoring and broadcasting system 10.

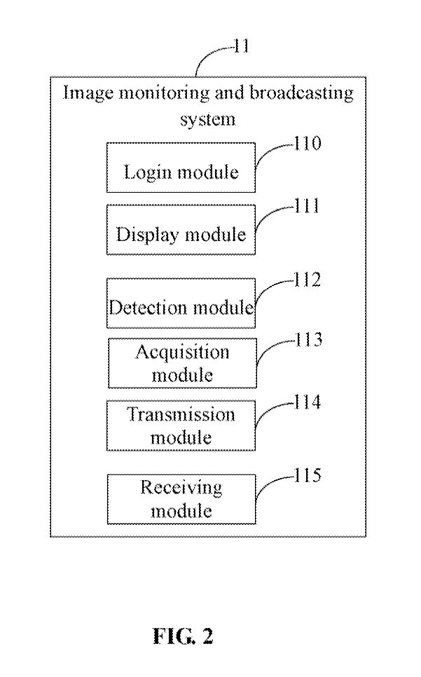

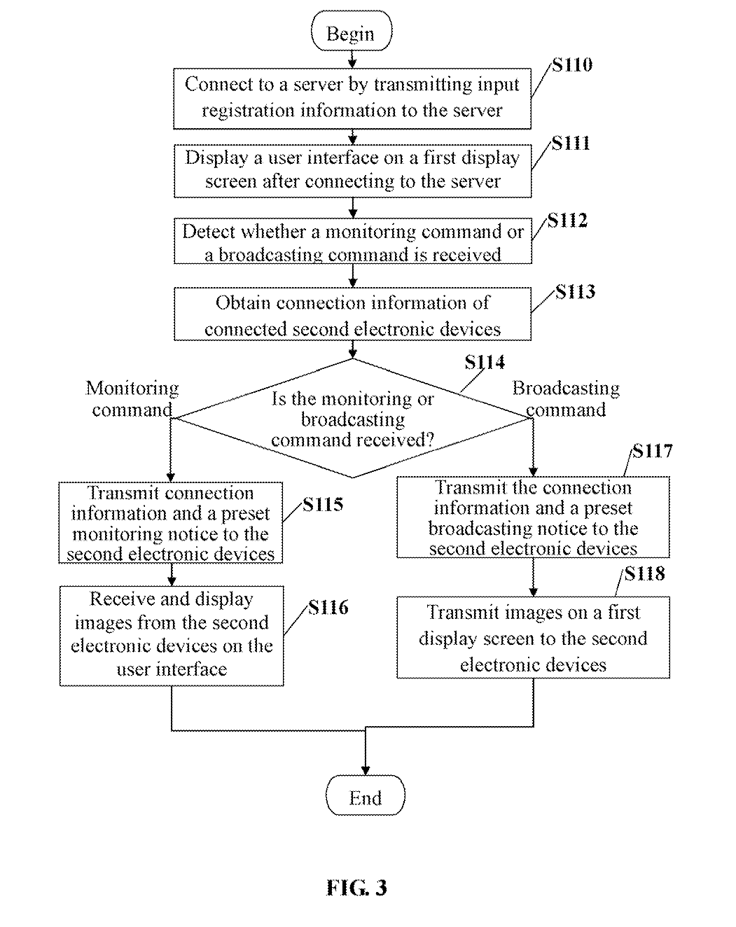

FIG. 2 shows that the image monitoring and broadcasting system 10 includes a plurality of function modules, such as a login module 110, a display module 111, a detection module 112, an acquisition module 113, a transmission module 114, and a receiving module 115. The modules 110-115 include computerized code in the form of one or more programs that are stored in the storage device 14 of the first electronic device 1. The computerized code includes instructions that are executed by the at least one processor 13 of the first electronic device 1 to provide functions of the image monitoring and broadcasting system 10. Detailed descriptions of the functions of the modules 110-115 are given below with reference to FIG. 3.

FIG. 3 is a flowchart of one embodiment of an image monitoring and broadcasting method. Depending on the embodiment, additional steps may be added, others removed, and the ordering of the steps may be changed.

In step S110, the login module 110 connects the first electronic device 1 to the server 2 by transmitting an account name and a password input of the first electronic device 1 to the server 2 through the wireless network 4. After the server 2 determines that the first electronic device 1 is connected successfully, the server 2 records the connection information of the first electronic device 1.

In step S111, the display module 111 displays the initial interface of the user interface 12 on the first display screen 12.

In step S112, the detection module 112 detects whether a monitoring command or a broadcasting command is received from the user interface 12 in real-time. The monitoring command is determined to be received when the monitoring button is pressed, or the broadcasting command is determined to be received when the broadcasting button is pressed.

In step S113, the acquisition module 113 acquires the connection information of one or more connected second electronic devices 3 which have been connected to the server 2.

In step S114, the detection module 112 determines the received command is the monitoring command or the broadcasting command. If the monitoring command is determined to be received, steps S115-S116 would be executed. If the broadcasting command is determined to be received, steps S117-S118 would be executed.

In step S115, the transmission module 114 transmits the connection information of the first electronic device 1 and a preset monitoring notice to the connected second electronic devices 3, according to the acquired connection information of the connected second electronic devices 3. When one of the connected second electronic devices 3 receives the preset monitoring notice from the first electronic device 1, the connected second electronic device 3 transmits images displayed on the second display screen 30 using an image transmission technology according to the identification code of the first electronic device 1 and the wireless network 4.

In step S116, the receiving module 115 receives the images displayed on the second display screen 30 from the connected second electronic devices 3 and displays the received images on the user interface 12 continuously. The receiving module 115 searches for a matched identifier field from the identifier fields on the monitoring interface according to the acquired account name of each of the connected second electronic devices 3. The receiving module 115 further determines a matched identifier code corresponding to the matched identifier field according to the acquired account name corresponding to the matched identifier code. The receiving module 115 displays the received images in an image field corresponding to the matched identifier field, and then the procedure ends.

In step S117, the transmission module 114 transmits the connection information of the first electronic device 1 and a preset broadcasting notice to the connected second electronic devices 3. When one of the connected second electronic devices 3 receives the preset broadcasting notice from the first electronic device 1, the connected second electronic device 3 receives the images transmitted from the first electronic device 1 to be displayed on the second display screen 30. In one embodiment, if the user interface 12 is shown in a maximum window, the user interface 12 is changed to be shown in a minimum window or a floating window on the first electronic device 1 after the broadcasting command is received. It is convenient for users to select a target image to broadcast to the second electronic devices 3.

In step S118, the transmission module 114 transmits the images displayed on the first display screen 11 to the connected second electronic devices 3 continuously, and then the procedure ends. The transmission module 114 transmits the images displayed on the second display screen 11 using the image transmission technology according to the required identification codes of the connected second electronic devices 3 and the wireless network 4.

In one embodiment, the monitoring interface of the user interface 12 may further include an exit button. If the exit button is pressed, the transmission module 114 stops transmitting the images or the receiving module 115 stops receiving the images, and the display module 110 exits the user interface 12. If the user interface 12 has been exited, the procedure of the image monitoring and broadcasting ends.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. An image monitoring and broadcasting method being executed by a processor of a first electronic device, the first electronic device in communication with a server and one or more second electronic devices, the method comprising:
displaying a user interface of the first electronic device on a first display screen of the first electronic device;
acquiring connection information of connected second electronic devices that are connected with the server through a wireless network, when a monitoring command or a broadcasting command is received from the user interface, the connection information comprising an account name and an identifier code; and
if the monitoring command is received, transmitting connection information of the first electronic device and a preset monitoring notice to the connected second electronic devices according to the acquired connection information, receiving images displayed on a second display screen of each of the connected second electronic devices, and displaying the received images on the user interface; or
if the broadcasting command is received, transmitting the connection information of the first electronic device and a preset broadcasting notice to the connected second electronic devices, and transmitting images displayed on the first display screen to the second display screen of the connected second electronic devices.

2. The method of claim 1, wherein the user interface comprises an initial interface displaying a monitoring button and a broadcasting button, the monitoring command is determined to be received when the monitoring button is pressed, or the broadcasting command is determined to be received when the broadcasting button is pressed.

3. The method of claim 1, wherein the user interface comprises a monitoring interface for displaying a plurality of identifier fields and image fields corresponding to the identifier fields, the image fields displaying the images transmitted from the connected second electronic devices, and the identifier fields being established corresponding to account names of the second electronic devices.

4. The method of claim 3, wherein the received images from the connected second electronic device are displayed on the user interface by:
searching for a matched identifier field from the identifier fields in the monitoring interface according to an acquired account name of each of the connected second electronic device;
determining a matched identifier code corresponding to the matched identifier field according to the acquired account name corresponding to the matched identifier code; and
displaying the received images in an image field corresponding to the matched identifier field according to the matched identifier code.

5. The method of claim 3, wherein the monitoring interface of the user interface further comprises an exit button, the images are stopped receiving from or transmitting to the connected second electronic devices and the user interface is exited if the exit button has been pressed.

6. The method of claim 1, wherein the images displayed on the first display screen are transmitted to the connected second electronic devices using an image transmission technology according to the required identification codes of the connected second electronic devices and the wireless network.

7. A first electronic device in communication with a server and one or more second electronic devices, the first electronic device comprising:
at least one processor; and
a storage device storing one or more programs, when executed by the at least one processor, cause the at least one processor to perform operations of:
displaying a user interface of the first electronic device on a first display screen of the first electronic device;
acquiring connection information of connected second electronic devices that are connected with the server through a wireless network, when a monitoring command or a broadcasting command is received from the user interface, the connection information comprising an account name and an identifier code; and
if the monitoring command is received, transmitting connection information of the first electronic device and a preset monitoring notice to the connected second electronic devices according to the acquired connection information, receiving images displayed on a second display screen of each of the connected second electronic devices, and displaying the received images on the user interface; or
if the broadcasting command is received, transmitting the connection information of the first electronic device and a preset broadcasting notice to the connected second electronic devices, and transmitting images displayed on the first display screen to the second display screen of the connected second electronic devices.

8. The first electronic device of claim 7, wherein the user interface comprises an initial interface for displaying a monitoring button and a broadcasting button, the monitoring command is determined to be received when the monitoring button is pressed, or the broadcasting command is determined to be received when the broadcasting button is pressed.

9. The first electronic device of claim 7, wherein the user interface comprises a monitoring interface for displaying a plurality of identifier fields and image fields corresponding to the identifier fields, the image fields displaying the images transmitted from the second electronic devices, and the identifier fields being established corresponding to account names of the second electronic devices.

10. The first electronic device of claim 9, wherein the received images from the connected second electronic device are displayed on the user interface by:
searching for a matched identifier field from the identifier fields in the monitoring interface according to an acquired account name of each of the connected second electronic device;
determining a matched identifier code corresponding to the matched identifier field according to the acquired account name corresponding to the matched identifier code; and
displaying the received images in an image field corresponding to the matched identifier field according to the matched identifier code.

11. The first electronic device of claim 9, wherein the monitoring interface of the user interface further comprises an exit button, the images are stopped receiving from or transmitting to the connected second electronic devices and the user interface is exited if the exit button has been pressed.

12. The first electronic device of claim 7, wherein the images displayed on the first display screen are transmitted to the connected second electronic devices using an image transmission technology according to the required identification codes of the connected second electronic devices and the wireless network.

13. A non-transitory computer-readable medium having stored thereon instructions that, when executed by at least one processor of a first electronic device, the first electronic device in communication with a server and one or more second electronic devices, cause the at least one processor to perform operations of:
displaying a user interface of the first electronic device on a first display screen of the first electronic device;
acquiring connection information of connected second electronic devices that are connected with the server through a wireless network, when a monitoring command or a broadcasting command is received from the user interface, the connection information comprising an account name and an identifier code; and
if the monitoring command is received, transmitting connection information of the first electronic device and a preset monitoring notice to the connected second electronic devices according to the acquired connection information, receiving images displayed on a second display screen of each of the connected second electronic devices, and displaying the received images on the user interface; or
if the broadcasting command is received, transmitting the connection information of the first electronic device and a preset broadcasting notice to the connected second electronic devices, and transmitting images displayed on the first display screen to the second display screen of the connected second electronic devices.

14. The medium of claim 13, wherein the user interface comprises an initial interface for displaying a monitoring button and a broadcasting button, the monitoring command is determined to be received when the monitoring button is pressed, or the broadcasting command is determined to be received when the broadcasting button is pressed.

15. The medium of claim 13, wherein the user interface comprises a monitoring interface for displaying a plurality of identifier fields and image fields corresponding to the identifier fields, the image fields displaying the images transmitted from the second electronic devices, and the identifier fields being established corresponding to account names of the second electronic devices.

16. The medium of claim 15, wherein the received images from the connected second electronic device are displayed on the user interface by:
searching for a matched identifier field from the identifier fields in the monitoring interface according to an acquired account name of each of the connected second electronic device;
determining a matched identifier code corresponding to the matched identifier field according to the acquired account name corresponding to the matched identifier code; and
displaying the received images in an image field corresponding to the matched identifier field according to the matched identifier code.

17. The medium of claim 15, wherein the monitoring interface of the user interface further comprises an exit button, the images are stopped receiving from or transmitting to the connected second electronic devices and the user interface is exited if the exit button has been pressed.

18. The medium of claim 13, wherein the images displayed on the first display screen are transmitted to the connected second electronic devices using an image transmission technology according to the required identification codes of the connected second electronic devices and the wireless network.
